(19) United States
(12) Patent Application Publication
(10) Pub. No.: US 2006/0202626 A1
(43) Pub. Date: Sep. 14, 2006

(54) Plasma display panel

(75) Inventor: Seok-Gyun Woo, Suwon-si (KR)

Correspondence Address: H.C. PARK & ASSOCIATES, PLC, 8500 LEESBURG PIKE, SUITE 7500, VIENNA, VA, 22182, US

(73) Assignee: Samsung SDI Co., Ltd.

(21) Appl. No.: 11/368,460

(22) Filed: Mar. 7, 2006

(30) Foreign Application Priority Data
Mar. 12, 2005 (KR) 10-2005-0020789

(51) Int. Cl. H01J 61/04; G09G 3/28; H01J 17/00

(52) U.S. Cl. 313/631; 313/581; 345/60

(57) ABSTRACT

A plasma display panel includes a first substrate, a second substrate arranged substantially parallel to the first substrate, and an electrode sheet arranged between the first substrate and the second substrate. The electrode sheet includes discharge cells that generate discharge, barrier ribs that partition the discharge cells, X electrodes that are common electrodes, Y electrodes that are scanning electrodes, and at least one electrode terminal arranged on the electrode sheet and coupled with an electrode.

### CROSS REFERENCE TO RELATED APPLICATION

This application claims priority to and the benefit of Korean Patent Application No. 10-2005-0020789, filed on Mar. 12, 2005, which is hereby incorporated by reference for all purposes as if fully set forth herein.

### BACKGROUND OF THE INVENTION

1. Field of the Invention

The present invention relates to a plasma display panel which may prevent an electrode terminal from being damaged during a manufacturing process and may simplify the manufacturing process for an electrode and the electrode terminal.

2. Discussion of the Background

Plasma display panels are flat display panels which display an image using gas discharge. Plasma display panels are advantageous because of their potentially large screen size, thinness, high picture quality, and wide viewing angle.

A plasma display panel may include first and second substrates, which face each other and are spaced apart, a discharge cell that generates discharge, and electrodes to which voltages are applied. Ultraviolet rays are discharged from discharge gas in the discharge cell due to a direct current (DC) or an alternating current (AC) applied to the electrodes. The ultraviolet rays excite a phosphor layer, which emits visible light and allows an image to be displayed.

A plasma display panel may include address electrodes that generate address discharge and sustain electrodes that generate sustain discharge. The address and sustain electrodes may be coupled with an operating circuit by a signal transfer means. The operating circuit generates an electrical signal to operate the plasma display panel. The sustain electrodes may include an X electrode, which is a common electrode, and a Y electrode, which is a scanning electrode. The Y electrode and the address electrode generate the address discharge together.

The electrodes may be coupled with the signal transfer means via their electrode terminals.

FIG. 1 is a schematic diagram illustrating a conventional plasma display panel. Referring to FIG. 1, an X electrode terminal 106a and a Y electrode terminal 107a are each arranged on an edge of a first substrate 101, and address electrode terminals 103a are arranged on both edges of a second substrate 102. Alternatively, the address electrode terminals 103a may be formed on only one edge of the second substrate 102.

Some edges of the electrode terminals 106a, 107a, and 103a are coupled with a signal transfer means (not shown), and other edges of the electrode terminals 106a, 107a, and 103a are coupled with each of the electrodes (not shown).

When an operating circuit (not shown) generates an electrical signal for discharge, the electrical signal is transferred to the electrodes after sequentially passing through the signal transfer means and the electrode terminals 106a, 107a, and 103a.

The electrode terminals 106a, 107a, and 103a are formed along with the electrodes and undergo a refining process during the process of being formed on the first and second substrates 101 and 102.

However, the electrode terminals 106a, 107a, and 103a of a conventional plasma display panel may be easily damaged by physical force or moisture applied during the refining process.

### SUMMARY OF THE INVENTION

The present invention provides a plasma display panel in which an electrode and its terminal arranged on an electrode sheet which is interposed between a pair of substrates so that the electrode terminal is protected from damage during the manufacturing process.

The present invention also provides a plasma display panel in which an electrode and its terminal are arranged on the same electrode sheet so that the electrode manufacturing process is simplified.

Additional features of the invention will be set forth in the description which follows, and in part will be apparent from the description, or may be learned by practice of the invention.

The present invention discloses a plasma display panel, including a first substrate; a second substrate arranged substantially parallel to the first substrate; and an electrode sheet arranged between the first substrate and the second substrate, wherein the electrode sheet includes discharge cells that generate discharge; barrier ribs that partition the discharge cells; X electrodes that are common electrodes; Y electrodes that are scanning electrodes; and at least one electrode terminal arranged on the electrode sheet and coupled with an electrode.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a schematic diagram illustrating a conventional plasma display panel.

FIG. 2 is a schematic diagram of a plasma display panel according to an exemplary embodiment of the present invention.

FIG. 3 is a plan view of an electrode sheet of the plasma display panel illustrated in FIG. 2.

FIG. 4 is a schematic diagram of the inside of the electrode sheet illustrated in FIG. 3.

FIG. 5 is a partial cutaway exploded perspective view taken by enlarging a portion D of the plasma display panel illustrated in FIG. 2.

FIG. 6A is a partial cutaway cross-sectional view taken along line VI-VI of the plasma display panel illustrated in FIG. 5.

FIG. 6B is a partial cutaway cross-sectional view of a plasma display panel according to an exemplary embodiment of the present invention.

FIG. 7 is a partial cutaway cross-sectional view of a plasma display panel according to an exemplary embodiment of the present invention.

FIG. 8 is a schematic diagram of a plasma display panel according to an exemplary embodiment of the present invention.

FIG. 9A is a partial cutaway cross-sectional view of the plasma display panel illustrated in FIG. 8.

FIG. 9B is a partial cutaway cross-sectional view of a plasma display panel according to an exemplary embodiment of the present invention.

FIG. 10 is a schematic diagram of a plasma display panel according to an exemplary embodiment of the present invention.

FIG. 11 is a schematic diagram of a plasma display panel according to an exemplary embodiment of the present invention.

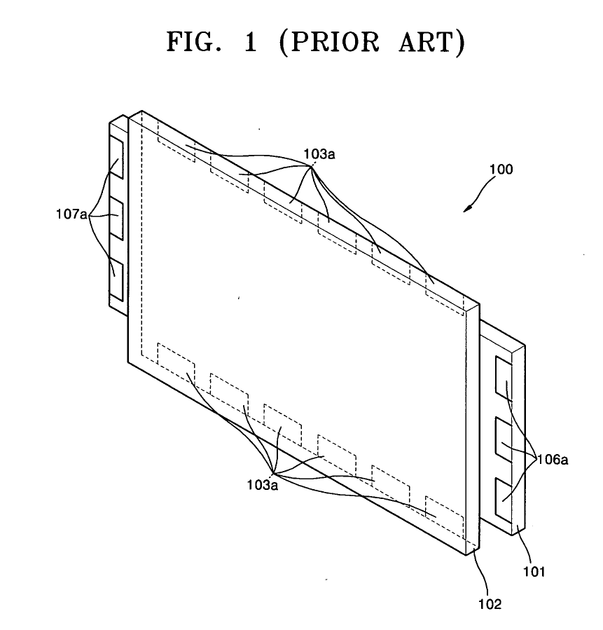

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

It will be understood that when an element such as a layer, film, region or substrate is referred to as being “on” another element, it can be directly on the other element or intervening elements may also be present. In contrast, when an element is referred to as being “directly on” another element, there are no intervening elements present.

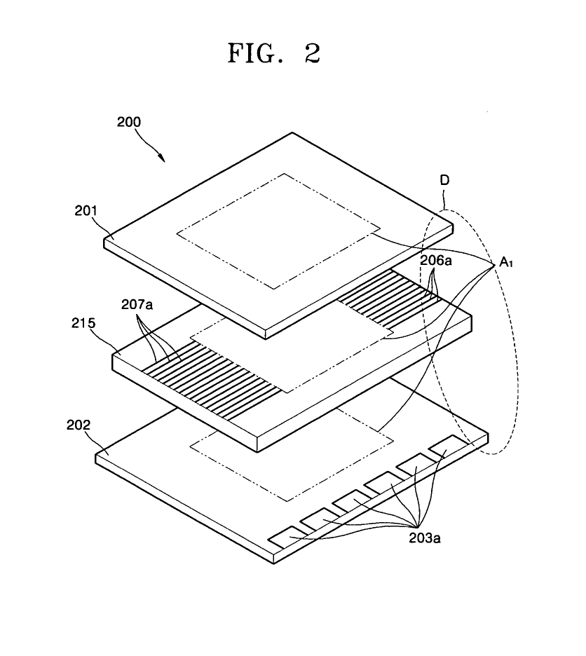

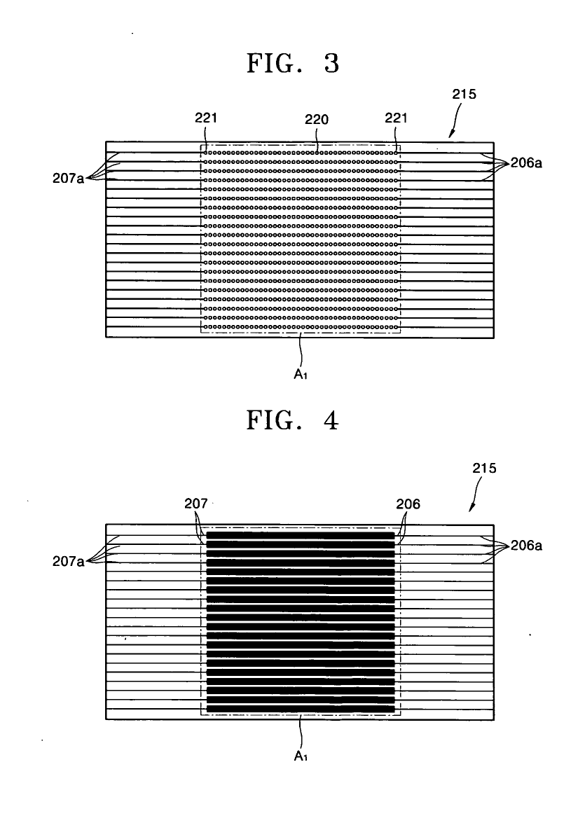

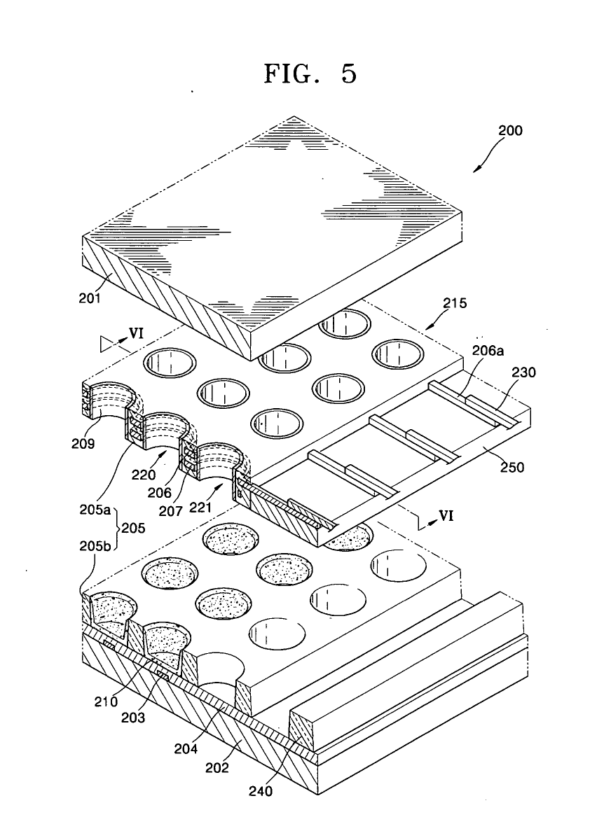

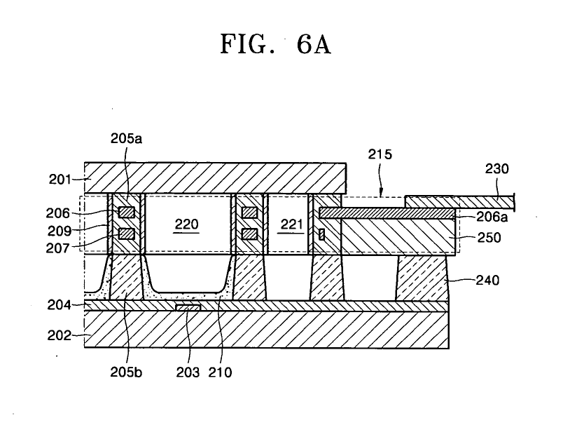

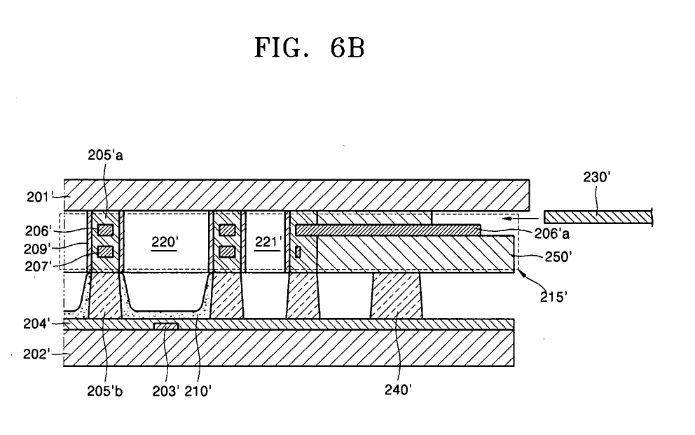

Referring to FIG. 2, FIG. 3, FIG. 4, FIG. 5, and FIG. 6A, a plasma display panel 200 according to an exemplary embodiment of the present invention may include a first substrate 201, a second substrate 202, and an electrode sheet 215. The first substrate 201 and the second substrate 202 may face each other and may be separated by a gap. The electrode sheet 215 may include a first barrier rib 205a, which defines discharge cells 220 and 221, X electrodes 206, which are common electrodes, and Y electrodes 207, which are scanning electrodes to which voltages may be applied. The discharge cells 220 and 221 may be interposed between the first and second substrates 201 and 202 and may generate discharge.

The plasma display panel 200 may include the first substrate 201 on one side of the electrode sheet 215 and the second substrate 202 on the other side of the electrode sheet 215. Address electrode terminals 203a may be arranged on the second substrate 202.

The electrode sheet 215 may be formed using a thick film ceramic sheet (TFCS) method or other various methods. The TFCS method may produce a high quality pattern by foaming, printing, and drying a ceramic substrate (refer to 10^{th} International Display Workshop IDW'03, p897).

The electrode sheet 215 may include at least one electrode terminal 206a coupled with the X electrodes 206 and at least one electrode terminal 207a coupled with the Y electrodes 207. The X electrodes 206 and the Y electrodes 207 are sustain electrodes.

Electrode terminals arranged on the electrode sheet 215 may be less likely to sustain damage due to physical force applied during the manufacturing process than electrode terminals arranged on the first and second substrates 201 and 202. Furthermore, the process of manufacturing the electrode terminals 206a and 207a may be simplified by arranging the electrode terminals on the electrode sheet.

X electrode terminals 206a coupled with the X electrodes 206 and Y electrode terminals 207a coupled with the Y electrodes 207 may be arranged on different edges of the electrode sheet 215, such as opposite edges.

A signal transfer means 230 may be coupled with the edges of each of the electrode terminals 206a and 207a arranged on the electrode sheet 215. The signal transfer mean 230 may be a flexible printed circuit or a tape carrier package (TCP) that is coupled with an operating circuit (not shown). The operating circuit may generate an electrical signal for operating the electrode terminals 206a and 207a and the plasma display panel 200.

Referring to FIG. 5 and FIG. 6A, at least one terminal of the X electrode terminals 206a and the Y electrode terminals 207a may have an exposed surface facing toward the first substrate 201 so that the signal transfer means 230 may cover and closely adhere to the exposed surface. Additionally or alternatively, at least one terminal of the X electrode terminals 206a and the Y electrode terminals 207a may have an exposed surface facing toward the second substrate 202.

As illustrated in FIG. 5 and FIG. 6A, the X electrode terminal 206a may extend from the X electrode 206 located in the first barrier rib 205a that defines dummy cells 221 outside the outermost discharge cell 220. The X electrode terminals may be arranged on a dummy unit 250 of the electrode sheet 215. Although not shown, the structure of the Y electrode terminals 207a may be substantially identical to that of the X electrode terminals 206a.

A sealing unit 240, such as frit glass, may be interposed between the dummy unit 250 and a dielectric layer 204 arranged on the second substrate 202 to seal the inner space of the plasma display panel 200.

The edges of the electrode sheet 215 on which the X electrode terminals 206a and the Y electrode terminals 207a are arranged may extend past an edge of at least one of the first and second subtrates 201 and 202, and may thus be exposed. Referring to FIG. 6A, the edge of the electrode sheet 215 on which the X electrode terminals 206a are arranged may extend past the edge of the first substrate 201, and may extend to one edge of the second substrate 202. Although not shown, the structure and arrangement of the Y electrode terminals 207a between the first and second substrates 201 and 202 may be substantially identical to that of the X electrode terminals 206a so that operational space required to couple the signal transfer means 230 with the electrode terminals 206a and 207a may be obtained.

A cell region A₁, which includes the discharge cells 220 that generate gas discharge and the dummy cells 221 that do not generate gas discharge, may be interposed between the edge of the electrode sheet 215 on which the X electrode terminals 206a are arranged and the other edge of the electrode sheet 215 on which the Y electrode terminals 207a are arranged. The cell region A₁ may be spaced apart from both edges by a predetermined distance.

The barrier ribs 205 that define the discharge cells 220 and the dummy cells 221 may include a first barrier rib 205a and a second barrier rib 205b. The first barrier rib 205a may be arranged on the electrode sheet 215 and the second barrier rib 205b may be arranged on the second substrate 202. Alternatively, the first and second barrier ribs 205a and 205b may be arranged on the electrode sheet 215.

The discharge cells 220 may contain discharge gas and a phosphor layer 210. The discharge gas may include one or more of neon (Ne), helium (He), and argon (Ar), and may also include xenon (Xe). The phosphor layer 210 may be a red, green, or blue (RGB) emitting phosphor layer to allow the plasma display panel 200 to display a color image. The RGB emitting phosphor layers may be combined in the discharge cells 220 to form a unit pixel for realizing the color image. The RGB emitting phosphor layers may be (Y,Gd)BO₃:Eu³⁺, Zn₂Si0₄:Mn²⁺, and BaMgAl₁₀O₁₇:Eu²⁺, respectively.

A barrier rib-embedded electrode method and a ring plasma method may be applied to the plasma display panel 200 according to exemplary embodiments of the present invention. Alternatively, other various methods including a tri-electrode surface discharge and an opposite type sustain method may be applied to the plasma display panel 200 of the present invention.

The ring plasma method may produce a ring-shaped gas discharge in the discharge cells 220 surrounded by the sustain electrodes 206 and 207 for sustaining discharge.

Electrodes included in the electrode sheet 215 may be arranged facing each other in the barrier ribs 205 to surround the discharge cells 220. The electrodes included in the electrode sheet 215 may include at least one of the X electrodes 206 and at least one of the Y electrodes 207. The X electrodes 206 are common electrodes and the Y electrodes 207 are scanning electrodes.

The X electrodes 206 may extend to surround the discharge cells 220 arranged in a direction in the first barrier rib 205a, and the Y electrodes 207 may extend to surround the discharge cells 220 arranged in a direction in the first barrier rib 205a.

The sustain electrodes 206 and 207 in the first barrier rib 205a may not prevent visible light discharged from the discharge cells 220 from being transmitted. Therefore, the sustain electrodes 206 and 207 need not necessarily be formed of transparent indium tin oxide (ITO) electrodes, but may be formed of Ag, Cu, Cr, or other metals which are inexpensive and have good electric conductivity. This may avoid screen unevenness, which ITO electrodes may cause, and may also decrease manufacturing costs.

Alternatively, the X electrodes 206 and the Y electrodes 207 may cross each other. In this case, address electrodes 203 may not be required because voltages may be applied between both electrodes 206 and 207 to select the discharge cells 220.

The electrode sheet 215 may include a protection layer 209 that covers at least a part of the barrier ribs 205. The protection layer 209 may be deposited on the electrode sheet 215 using MgO. However, since the protection layer 209 is not located in the light path, it may have good secondary electron discharge characteristics. The protection layer 209 may be formed of carbon nano tubes (CNT), which are very durable.

The barrier ribs 205 may be formed of a glass component including elements such as Pb, B, Si, Al, and O. and may also include a dielectric layer, including fillers such as ZrO₂, TiO₂, and Al₂O₃ and pigments such as Cr, Cu, Co, Fe, TiO₂.

When the barrier ribs 205 include a dielectric layer charged particles are induced to accumulate rib charges used for discharge using a pulse voltage applied to the sustain electrodes 206 and 207 in the barrier ribs 205. This allows the plasma display panel 200 to operate using a memory effect and may prevent the sustain electrodes 206 and 207 from being damaged due to the collision of the charge particles accelerated during discharge.

The phosphor layer 210 may be located in the space defined by the second barrier rib 205b and the second substrate 202, in the space defined by the first barrier rib 205a and the first substrate 201, or in both spaces.

The X electrodes 206 and the Y electrodes 207 may be arranged substantially parallel to each other. The address electrodes 203 may be arranged on the second substrate 202 and may cross the X electrodes 206 and the Y electrodes 207 to make it possible to select the discharge cells 220 that generate discharge by properly selecting the Y electrodes 207 and the address electrodes 203.

The dielectric layer 204 may be arranged on the second substrate 202, and the address electrodes 203 may be arranged in the dielectric layer 204. The address electrodes 203 and/or dielectric layer 204, may alternatively be formed on the electrode sheet 215 instead of on the second substrate 202. The dielectric layer 204 that covers the address electrodes 203 may be omitted, because the phosphor layers 210 that cover the address electrodes 203 may function as the dielectric layer 204.

The sustain electrodes 206 and 207 may be located in the first barrier rib 205a as shown in FIG. 5 and FIG. 6A, in the second barrier rib 205b, or may be divided between the first and second barrier ribs 205a and 205b.

Furthermore, two or more sustain electrodes 206 and 207 may be arranged in each discharge cell.

The vertical sections of the discharge cell 220 and the dummy cell 221 may be closed-shaped as illustrated in FIG. 5 and FIG. 6A, and the sustain electrodes 206 and 207 may surround the discharge cells 220 in the barrier ribs 205, thereby causing three-dimensional discharge and increasing the amount of discharge. Closed-shapes may include closed-type curves such as circles and ellipses, and closed-type polygons such as rectangles or hexagons. Alternatively, the vertical sections of the discharge cell 220 and the dummy cell 221 may be stripe-shaped.

The operation of the plasma display panel 200 will now be described.

An address voltage may be applied between the address electrodes 203 and the Y electrodes 207 to generate address discharge, thereby selecting the discharge cells 220 for generating sustain discharge.

A discharge sustain voltage may be applied between the X electrodes 206 and the Y electrodes 207 of the selected discharge cell 220 to cause the rib charges accumulated in the X electrodes 206 and the Y electrodes 207 to generate sustain discharge, which lowers the energy level of the discharge gas excited during the sustain discharge and causes the discharge gas to discharge ultraviolet rays.

The ultraviolet rays excite the phosphor layers 210 in the discharge cells 220, and the energy level of the excited phosphor layers 210 is lowered to discharge visible light. The visible light is transmitted through the first substrate 201 to form an image.

FIG. 6B is a partial cutaway cross-sectional view illustrating a modification of an electrode terminal of the plasma display panel illustrated in FIG. 2. and FIG. 6A. Referring to FIG. 6B, a plasma display panel may include a first substrate 201′, an electrode sheet 215′, and a second substrate 202′.

The electrode sheet 215′ may include a discharge cell 220′, a dummy cell 221, a first barrier rib 205a′, a protection layer 209′, sustain electrodes 206′ and 207′, an X electrode terminal 206a′, a Y electrode terminal (not shown), and a dummy unit 250′.

The second substrate 202′ may include an address electrode 203′, a dielectric layer 204′, a second barrier rib 205b′, a phosphor layer 210′, and a sealing unit 240′.

A part of the X electrode terminal 206a′ may be covered by the dummy unit 250′ of the electrode sheet 215′ and other parts of the X electrode terminal 206a′ may be exposed on the surface of the dummy unit 250′ facing toward the first substrate 201′. The edge of the electrode sheet 215′ on which the X electrode terminal 206a′ is formed may correspond to the edges of the first substrate 201′ and the second substrate 202′. Although not shown, the arrangement of the Y electrode terminal in the electrode sheet 215′ between the first and second substrates 201′ and 202′ may be substantially identical to the X electrode terminal 206a′.

A signal transfer means 230′ may be inserted into the space formed between the first substrate 201′ and the electrode sheet 215′ and may adhere closely to the X electrode terminal 206a′.

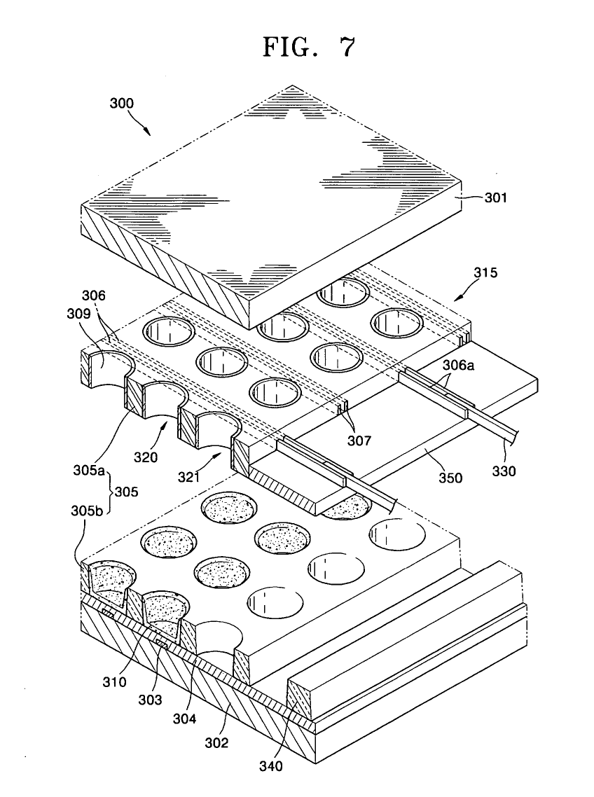

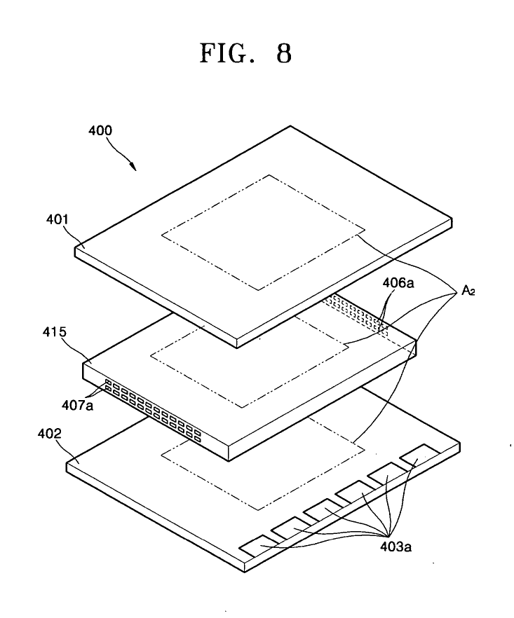

FIG. 7 is a partial cutaway cross-sectional view illustrating a modification of the plasma display panel illustrated in FIG. 2. Referring to FIG. 7, a modified plasma display panel 300 may include a first substrate 301, an electrode sheet 315, and a second substrate 302.

The electrode sheet 315 may include a discharge cell 320, a dummy cell 321, first barrier ribs 305a, a protection layer 309, sustain electrodes 306 and 307, an X electrode terminal 306a, a Y electrode terminal (not shown), and a dummy unit 350.

The second substrate 302 may include an address electrode 303, a dielectric layer 304, second barrier ribs 305b, a phosphor layer 310, and a sealing unit 340.

The first and second substrates 301 and 302 may define a plurality of discharge cells 320 and dummy cells 321. The first and second barrier ribs 305a and 305b may be spaced apart from each other between the first and second substrates 301 and 302, and may partition the discharge cells 320 and dummy cells 321.

The sustain electrodes 306 and 307 may be arranged to face each other in the first barrier ribs 305a, and may be separated by a predetermined discharge cell.

The sustain electrodes 306 and 307 may include X electrodes 306 and Y electrodes 307, respectively. The X electrodes 306 may be arranged in pairs in one of the first barrier ribs 305a and the Y electrodes 307 may be arranged in pairs in another of the first barrier ribs 305a, which faces and is adjacent to one of the first barrier ribs 305a. The signal transfer means 330 may be inserted between the pairs of electrodes 306 and 307 to closely couple the signal transfer means 330 with the electrodes 306 and 307. The X electrodes 306 and the Y electrodes 307 may be arranged substantially parallel to each other and may be stripe-shaped.

Address electrodes 303 may be arranged to cross the sustain electrodes 306 and 307 and may be located on the first substrate 301. The address electrodes 303 may be arranged to cross the discharge cells 320 and may be stripe-shaped.

The arrangement and materials of the phosphor layer 310, the protection layer 309, the dielectric layer 304, the barrier ribs 305a and 305b, the X electrode terminals 306a, the Y electrode terminals (not shown), the dummy unit 350, and the sealing unit 340 may be substantially identical to those of the plasma display panel using the barrier rib-embedded method and the ring plasma method illustrated in FIG. 5 and FIG. 6A.

The barrier rib-embedded electrode method and a ring plasma method may be applied to the plasma display panel of FIG. 7.

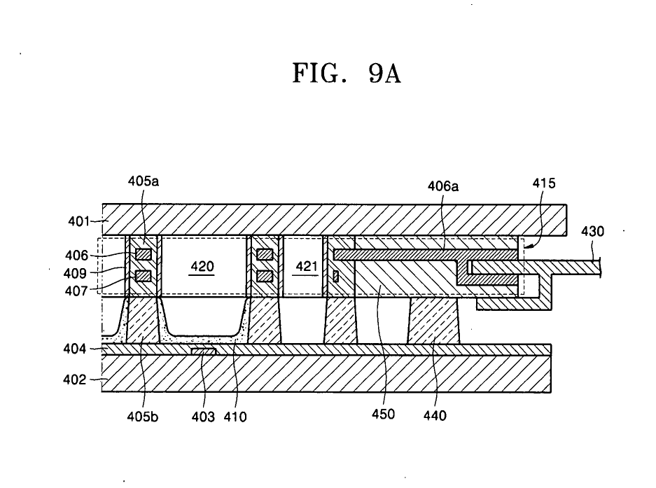

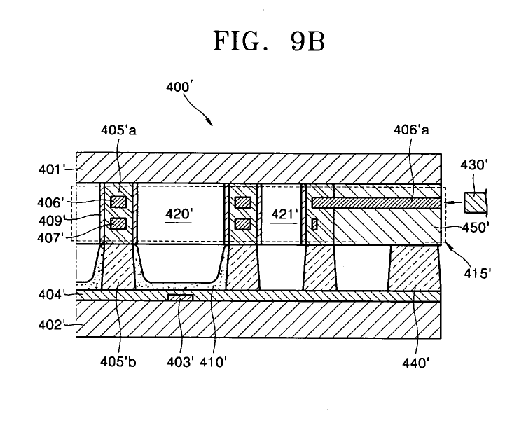

FIG. 8 is a schematic diagram of a modification of the arrangement structure of the electrode terminal of the plasma display panel illustrated in FIG. 2. FIG. 9A is a partial cutaway cross-sectional view illustrating the plasma display panel illustrated in FIG. 8. Referring to FIG. 8 and FIG. 9A, the plasma display panel 400 may include a first substrate 401, an electrode sheet 415, and a second substrate 402.

The electrode sheet 415 may include a discharge cell 420, a dummy cell 421, first barrier ribs 405a, a protection layer 409, sustain electrodes 406 and 407, an X electrode terminal 406a, a Y electrode terminal 407a, and a dummy unit 450.

The second substrate 402 may include an address electrode 403, an address electrode terminal 403a, a dielectric layer 404, second barrier ribs 405b, a phosphor layer 410, and a sealing unit 440.

In the plasma display panel 400, at least one of the X electrode terminals 406a and the Y electrode terminals 407a may be exposed on the side edge of the electrode sheet 415. Referring to FIG. 9A, the X electrode terminal 406a may be wholly covered by the dummy unit 450 except for the side edge thereof. The side edge may include a slot, into which the signal transfer means 430 may be inserted to closely combine the X electrode terminal 406a and the signal transfer means 430. The edge of the electrode sheet 415 on which the X electrode terminal 406a is arranged may be located inside the edges of the first and second substrates 401 and 402.

One edge of the signal transfer means 430 may also include a slot shape in which the top portion of the signal transfer means 430 slot may be adhered to the X electrode terminal 406a and the bottom portion of the signal transfer means 430 slot may be adhered to the bottom of the dummy unit 450, thereby closely combining the signal transfer means 430 and the dummy unit 450.

Although not shown, the structure and arrangement of the Y electrode terminals 407a between the first and second substrates 401 and 402 may be substantially identical to that of the X electrode terminals 406a.

A cell region A₂ including discharge cells (not shown) and dummy cells (not shown) may be interposed between the edge of the electrode sheet 415 on which the X electrode terminals 406a are formed and the edge of the electrode sheet 415 on which the Y electrode terminals 407a are formed, and may be spaced at a distance from the both edges.

FIG. 9B is a partial cutaway cross-sectional view illustrating a modification of an electrode terminal of the plasma display panel illustrated in FIG. 8. Referring to FIG. 9B, a modified plasma display panel 400′ may include a first substrate 401′, an electrode sheet 415′, and a second substrate 402′.

The electrode sheet 415′ may include a discharge cell 420′, a dummy cell 421′, first barrier ribs 405a′, a protection layer 409′, sustain electrodes 406′ and 407′, an X electrode terminal 406a′, a Y electrode terminal (not shown), and a dummy unit 450′.

The second substrate 402′ may include an address electrode 403′, a dielectric layer 404′, second barrier ribs 405b′, a phosphor layer 410′, and a sealing unit 440′.

The X electrode terminal 406a′ of FIG. 9B may include an X electrode terminal 406a′ with flat edges.

The edge of the electrode sheet 415′ on which the X electrode terminal 406a′ may be arranged to correspond to edges of the first substrate 401′ and the second substrate 402′. Although not shown, the structure and arrangement of the Y electrode terminals between the first and second substrates 401′ and 402′ may be substantially identical to those of the X electrode terminals 406a′.

Signal transfer means 430′ may be located in the side edge of the electrode sheet 415′, to closely combining the X electrode terminal 406a′ and the signal transfer means 430′.

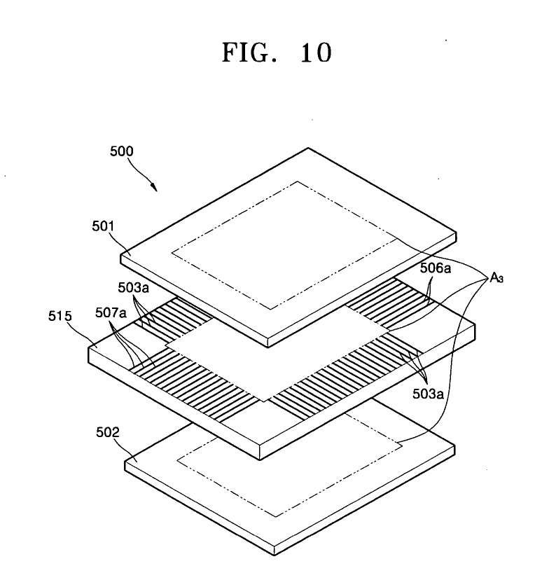

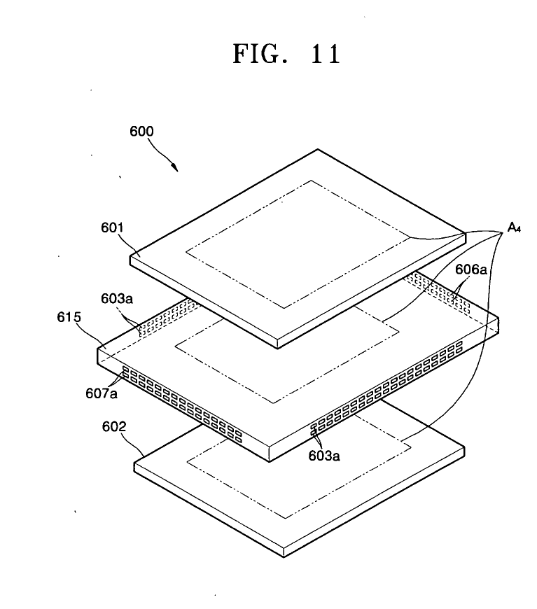

FIG. 10 is a schematic diagram of a plasma display panel 500 according to an exemplary embodiment of the present invention.

The plasma display panel 500 may include an electrode sheet 515 including X electrode terminals 506a, Y electrode terminals 507a, and address electrode terminals 503a. Although not shown, an address electrode may be arranged on the electrode sheet 515 and may be coupled with an edge of the address electrode terminals 503a. Arranging the address electrode terminals 503a on the electrode sheet 515 may prevent damage to the address electrode terminals 503a. Additionally, the electrode manufacturing process may be simplified because the electrode sheet 515 may include all of the electrodes 503, 506, and 507.

The address electrode terminals 503a may be arranged on both ends of the electrode sheet 515 on which the X electrode terminals 506a and the Y electrode terminals 507a are not formed as illustrated in FIG. 10. Alternatively, the address electrode terminals 503a may be arranged on only one edge of the electrode sheet 515. Either a single scan method or a dual scan method may be applied to the plasma display panel 500.

The edge of the electrode sheet 515 on which the X electrode terminals 506a are arranged, the edge of the electrode sheet 515 on which the Y electrode terminals 507a are arranged, and one or both edges of the electrode sheet 515 on which the address electrode terminals 503a are arranged may extend past an edge of at least one of the first and second substrates 501 and 502.

The specific arrangements of the X electrode terminals 506a and the Y electrode terminals 507a may be substantially identical to those of the plasma display panel 200.

The plasma display panel 500 may thus provide the operating space required to couple signal transfer means (not shown) with the electrode terminals 503a, 506a, and 507a.

A cell region A₃ including discharge cells (not shown) and dummy cells (not shown) may be arranged between the edge of the electrode sheet 515 on which the X electrode terminals 506a are arranged and the edge of the electrode sheet 515 on which the Y electrode terminals 507a are arranged, and between the ends on which the address/electrode terminals 503a are arranged, and may be spaced apart from these edges by a predetermined distance.

FIG. 11 is a schematic diagram of a modification of the arrangement structure of an electrode terminal of the plasma display panel illustrated in FIG. 10.

The modified plasma display panel 600 may include at least one of the X electrode terminals 606a, Y electrode terminals 607a, and address electrode terminals 603a exposed on the side edge of an electrode sheet 615 of the plasma display panel 600. The specific structure and arrangements of the address electrode terminals 603a may be substantially identical to those of the X electrode terminals 206 of the plasma display panel 200.

A signal transfer means (not shown) may be inserted into the electrode sheet 615 or adhered to the side edge of the electrode sheet 615 to couple the signal transfer means (not shown) with the electrode terminals 603a, 606a, and 607a.

A cell region A₄ including discharge cells (not shown) and dummy cells (not shown) may be interposed between the edge of the electrode sheet 615 on which the X electrode terminals 606a are arranged and the edge of the electrode sheet 615 on which the Y electrode terminals 607a are arranged, and between the ends on which the address electrode terminals 603a are arranged, and may be spaced apart from these edges by a predetermined distance.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A plasma display panel, comprising:
a first substrate;
a second substrate facing the first substrate; and
an electrode sheet arranged between the first substrate and the second substrate,
wherein the electrode sheet comprises:
discharge cells that generate discharge;
barrier ribs that partition the discharge cells;
common X electrodes;
scanning Y electrodes; and
at least one electrode terminal coupled with at least one electrode of the common X electrodes and the scanning Y electrodes.

2. The plasma display panel of claim 1,
wherein X electrode terminals coupled with X electrodes are arranged on a first edge of the electrode sheet, and Y electrode terminals coupled with Y electrodes are arranged on a second edge of the electrode sheet.

3. The plasma display panel of claim 2,
wherein at least one of the X electrode terminals and the Y electrode terminals are exposed on the surface of the electrode sheet facing the first substrate.

4. The plasma display panel of claim 2,
wherein at least one of the X electrode terminals and the Y electrode terminals are exposed on the surface of the electrode sheet facing the second substrate.

5. The plasma display panel of claim 2,
wherein at least one of the X electrode terminals and the Y electrode terminals are exposed on a side edge of the electrode sheet.

6. The plasma display panel of claim 2,
wherein the first edge of the electrode sheet and the second edge of the electrode sheet extend past the edge of at least one of the first substrate and the second substrate.

7. The plasma display panel of claim 1,
wherein a discharge cell contains discharge gas and a phosphor layer.

8. The plasma display panel of claim 1,
wherein an X electrode and a Y electrode are arranged in a barrier rib, are spaced apart from each other, and surround a discharge cell.

9. The plasma display panel of claim 1,
wherein an X electrode surrounds the discharge cells located in a direction.

10. The plasma display panel of claim 1,
wherein a Y electrode surrounds the discharge cells located in a direction.

11. The plasma display panel of claim 1,
wherein the X electrodes and the Y electrodes are arranged together in pairs facing each other in the barrier ribs, and the pairs are spaced apart from each other by the discharge cells in the barrier ribs.

12. The plasma display panel of claim 11,
wherein the X electrodes and the Y electrodes are substantially parallel to each other.

13. The plasma display panel of claim 11,
wherein the X electrodes and the Y electrodes have a stripe shape.

14. The plasma display panel of claim 1,
wherein the electrode sheet further comprises a protection layer that covers at least a part of the barrier ribs.

15. The plasma display panel of claim 1,
wherein the barrier ribs comprise a dielectric material.

16. The plasma display panel of claim 1, further comprising:
a phosphor layer arranged in a space defined by the first substrate and the barrier ribs.

17. The plasma display panel of claim 1, further comprising:
a phosphor layer arranged in a space defined by the second substrate and the barrier ribs.

18. The plasma display panel of claim 1,
wherein the X electrodes and the Y electrodes cross each other.

19. The plasma display panel of claim 1, further comprising:
address electrodes,
wherein the X electrodes and the Y electrodes are substantially parallel to each other, and the address electrodes cross the X electrodes and the Y electrodes.

20. The plasma display panel of claim 19,
wherein the address electrodes are arranged on the second substrate.

21. The plasma display panel of claim 19, further comprising:
a dielectric layer,
wherein the dielectric layer is arranged on the second substrate, and the address electrodes are arranged in the dielectric layer.

22. The plasma display panel of claim 19,
wherein the address electrodes are arranged on the electrode sheet.

23. The plasma display panel of claim 19,
wherein address electrode terminals are arranged on an edge of the electrode sheet on which the X electrode terminals and the Y electrode terminals are not formed, and
wherein the address electrode terminals are coupled with address electrodes.

24. The plasma display panel of claim 19,
wherein address electrode terminals are arranged on two edges of the electrode sheet on which the X electrode terminals and the Y electrode terminals are not formed, and
wherein the address electrode terminals are coupled with address electrodes.

25. The plasma display panel of claim 19,
wherein the first edge of the electrode sheet, the second edge of the electrode sheet, and the edge of the electrode sheet on which the address electrode terminals are arranged, extend past an edge of at least one of the first substrate and the second substrate.

26. The plasma display panel of claim 1,
wherein the electrode sheet comprises a ceramic sheet formed using a thick film ceramic sheet method.
